(19) United States
(12) Patent Application Publication
(10) Pub. No.: US 2026/0230503 A1
(43) Pub. Date: Aug. 6, 2026

(54) EVALUATING ELECTRONIC COMMUNICATIONS BASED ON INTERACTION DATA

(71) Applicant: Reken Corporation, San Francisco, CA (US)

(72) Inventors: Shuman Ghosemajumder, Mountain View, CA (US); Richard Griffiths, San Jose, CA (US); Sebastien Soudan, San Jose, CA (US); Christian Glauch, Oceanside, CA (US); Suraj Venkata Raman, Alamo, CA (US)

(73) Assignee: Reken Corporation, San Francisco, CA (US)

(21) Appl. No.: 19/044,356

(22) Filed: Feb. 3, 2025

Related U.S. Application Data
(60) Provisional application No. 63/643,402, filed on May 6, 2024.

(51) Int. Cl. H04L 9/40; H04L 51/212

(52) U.S. Cl. CPC H04L 63/1483; H04L 51/212; H04L 63/1425

(57) ABSTRACT

Techniques are provided for evaluating electronic communications based on interaction data. Observational data comprising interaction data is obtained on a user computing device. In a communication application executing on the user computing device, a command to send an electronic communication is detected. A risk level of the electronic communication is determined based on analyzing the interaction data, the risk level corresponding to a likelihood that the electronic communication is not generated by a human user. When the risk level of the electronic communication is below a risk threshold, a validation indicator is associated with the electronic communication, and sending of the electronic communication is allowed to proceed.

### FIELD OF THE DISCLOSURE

The present disclosure generally relates to electronic communications, and relates more specifically to identifying fraudulent electronic communications.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely based on their inclusion in this section.

When a malicious actor gains access to an email account, they can exploit the account for malicious purposes. Malicious actors may include unauthorized individuals, entities, and/or software agents. For example, malicious actors may use a compromised account to execute email account compromise (EAC) schemes, such as by sending electronic communications to obtain confidential information, spread malware, send spam communications, and send phishing communications, including spearphishing. The EAC schemes may include business email compromise (BEC) schemes that involve fraudulent activities carried out in a business context. For example, malicious actors may use the compromised account to send electronic communications with the intent to deceive employees, vendors, customers, and/or other parties by impersonating employees, managers, executives, and/or other trusted parties. BEC schemes often focus on financial fraud, such as to redirect payments and/or transfer funds to fraudulent accounts.

Email security systems typically focus on identifying anomalies in email content or sending patterns, but may not recognize fraudulent emails originating from a normally trusted source, thereby failing to detect the breach. For example, when a trusted device is compromised, traditional email security systems may fail to detect the malicious activity. Furthermore, advances in artificial intelligence (AI) have enabled AI-generated emails that mimic human communication patterns, heightening the effectiveness of deception while circumventing conventional detection methods. Techniques are needed to identify fraudulent electronic communications.

### SUMMARY

The appended claims may serve as a summary.

### BRIEF DESCRIPTION OF THE DRAWINGS

In the drawings:

FIG. 1 illustrates a computer system that includes a communication monitoring system executing on a user computing device in an example embodiment.

FIGS. 2A-2B illustrate an email object in an example embodiment.

FIG. 3 illustrates a computer system that includes a communication server system and a user computing device that sends an electronic communication, and a user computing device that receives the electronic communication in an example embodiment.

FIG. 4 is a swimlane diagram of a process for sending and receiving a validated electronic communication in an example embodiment.

FIG. 5 is a flow diagram of a process for evaluating electronic communications based on interaction data in an example embodiment.

FIG. 6 illustrates a computer system upon which an embodiment may be implemented.

While each of the drawing figures illustrates a particular embodiment for the purpose of providing a clear example, other embodiments may omit, add to, reorder, or modify any of the elements shown in the drawing figures. Unless otherwise specified, aspects disclosed with respect to an embodiment of an element in a figure may optionally be applied to another embodiment of the element in another figure. For purposes of illustrating clear examples, one or more figures may be described with reference to one or more other figures. However, using the particular arrangement illustrated in such other figure/s is not required in other embodiments.

### DETAILED DESCRIPTION

In the following description, numerous specific details are set forth in order to provide a thorough understanding of the subject matter of the present application. It will be apparent, however, to a person of ordinary skill that embodiments may be practiced without incorporating all aspects of the specific details described herein. The detailed description that follows describes exemplary embodiments and the features disclosed are not intended to be limited to the expressly disclosed combination(s). Therefore, unless otherwise noted, features disclosed herein may be combined to form additional combinations that were not otherwise shown for purposes of brevity.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and does not imply an ordering, timing, or any other characteristic of the referenced items unless otherwise specified; the term “and/or” as used herein refers to and encompasses any and all possible combinations of one or more of the associated listed items; that the terms “includes”, “including”, “comprises”, and/or “comprising” specify the presence of stated features but do not preclude the presence or addition of one or more other features. Unless otherwise specified: “such as” is intended to mean “such as but not limited to”; and examples are intended to be nonlimiting.

A “component” may be hardware and/or software stored in, or coupled to, a memory and/or one or more processors on one or more computers. As an alternative and/or addition, a component may comprise specialized circuitry. A component may be a standalone component, work in conjunction with one or more other components, contain one or more other components, and/or belong to one or more other components.

A “system” may be hardware and/or software stored in, or coupled to, a memory and/or one or more processors on one or more computers. As an alternative and/or addition, a component may comprise specialized circuitry. A system may be a standalone component, work in conjunction with one or more other systems, contain one or more other systems, and/or belong to one or more other systems. A system may be a computer system.

A “computer system” refers to one or more computers, such as one or more physical computers, virtual computers, and/or computing devices. For example, a computer system may be, or may include, one or more server computers, desktop computers, laptop computers, mobile devices, special-purpose computing devices with a processor, cloud-based computers, cloud-based clusters of computers, virtual machine instances, and/or other computing devices. A computer system may include another computer system, and a computing device may belong to two or more computer systems. Any reference to a “computer system” may mean one or more computers, unless expressly stated otherwise. When a computer system performs an action, the action is performed by one or more computers of the computer system.

A “device” may be a computer system, hardware, and/or software stored in, or coupled to, a memory and/or one or more processors on one or more computers. As an alternative and/or addition, a device may comprise specialized circuitry. For example, a device may be hardwired or persistently programmed to support a set of instructions to perform the functions discussed herein. A device may be a standalone device, work in conjunction with one or more other devices, contain one or more other devices, and/or belong to one or more other devices.

A “client” refers to a combination of integrated software components and an allocation of computational resources, such as memory, a computing device, and/or processes on a computing device for executing the integrated software components. The combination of the software and the computational resources is configured to interact with one or more servers over a network, such as the Internet. A client may refer to either the combination of components on one or more computers, or the one or more computers (also referred to as “client computing devices”).

A “server” refers to a combination of integrated software components and an allocation of computational resources, such as memory, a computing device, and/or processes on the computing device for executing the integrated software components. The combination of the software and the computational resources is dedicated to providing a particular type of function on behalf of clients of the server. A server may refer to either the one or more computing devices (also referred to as a “server system”) or the combination of components on one or more computing devices. A server system may include multiple servers; that is, a server system may include a first computing device and a second computing device, which may provide the same or different functionality to the same or different set of clients.

### GENERAL OVERVIEW

This document generally describes systems, methods, devices, and other techniques for evaluating electronic communications based on interaction data.

One aspect of the disclosure is directed to a method comprising: obtaining observational data comprising interaction data on a user computing device; detecting, in a communication application executing on the user computing device, a command to send an electronic communication; determining a risk level of the electronic communication based on analyzing the interaction data, the risk level corresponding to a likelihood that the electronic communication is not generated by a human user; and when the risk level of the electronic communication is below a risk threshold, associating a validation indicator with the electronic communication, and allowing sending of the electronic communication to proceed; wherein the method is performed by one or more processors.

In some examples, the method includes: when the risk level of the electronic communication is above the risk threshold, preventing sending of the electronic communication.

In some examples, the method includes: when the risk level of the electronic communication is above the risk threshold, sending a notification to a monitoring entity indicating that the user computing device is compromised.

In some examples, associating the validation indicator with the electronic communication comprises signing the electronic communication before allowing the sending of the electronic communication to proceed.

In some examples, associating the validation indicator comprises adding the validation indicator to metadata of the electronic communication.

In some examples, the electronic communication is an email.

In some examples, the method includes: obtaining electronic communication content corresponding to an incoming electronic communication; verifying a second validation indicator associated with the incoming electronic communication; and determining that a risk level of the incoming electronic communication is low based at least in part on verifying the second validation indicator associated with the incoming electronic communication.

In some examples, the observational data further comprises environmental data, and determining the risk level of the electronic communication is based on the environmental data.

In some examples, the observational data further comprises platform data, and determining the risk level of the electronic communication is based on the platform data.

In some examples, the method includes: maintaining a device score for the user computing device based on risk levels for multiple electronic communications sent on the user computing device; wherein determining the risk level of the electronic communication is based on the device score.

In some examples, the method includes: maintaining a user score for a user of an electronic communication account based on risk levels for multiple electronic communications sent from the electronic communication account of the user; wherein determining the risk level of the electronic communication is based on the user score.

One aspect of the disclosure is directed to a computer system comprising: one or more hardware processors; and at least one memory storing one or more instructions which, when executed by the one or more hardware processors, cause the one or more hardware processors to perform one or more methods described herein.

One aspect of the disclosure is directed to a non-transitory computer-readable medium storing instructions that, when executed by one or more processors of a computer system, cause the computer system to perform one or more methods described herein.

In some implementations, the various techniques described herein may achieve one or more of the following advantages: email account compromise (EAC) and/or business email compromise (BEC) attacks are detected and/or mitigated; computer systems are protected from phishing attacks, social engineering attacks, and other fraudulent attacks; sensitive data and/or systems are protected from breaches and other unauthorized access; monitoring and/or analysis may be integrated into user computing devices and/or communication applications to provide ongoing protection during usage; private data may be processed and/or retained locally on a user computing device; trusted sources are monitored to detect compromised devices and/or accounts; enterprise customers may increase their trustworthiness to other entities by validating electronic communications originating from the enterprise; and/or network effects may lead to increased protection between enterprise customers. Additional features and advantages are apparent from the specification and the drawings.

### SYSTEM OVERVIEW

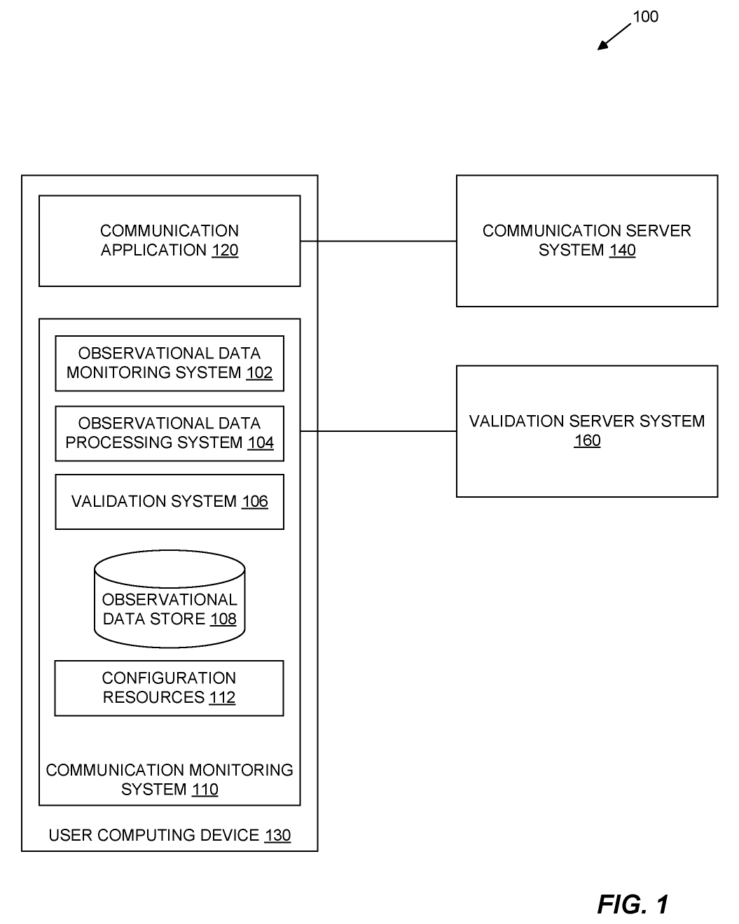

FIG. 1 illustrates a computer system that includes a communication monitoring system executing on a user computing device in an example embodiment. The computer system 100 includes a validation server system 160, a communication server system 140, and a user computing device 130. The user computing device 130 executes a communication application 120 and a communication monitoring system 110. While one user computing device 130, one communication application 120, one communication server system 140, and one validation server system 160 are shown, the computer system 100 may be adapted to include multiple user computing devices 130, multiple communication applications 120 on one or multiple user computing devices 130, multiple communication server systems 140, and/or multiple validation server systems 160 without departing from the spirit or the scope of this disclosure. The user computing device 130, the communication server system 140, and/or the validation server system 160 may communicate over a network, which may include one or more local area networks (LANs) and/or one or more wide area networks, such as the Internet.

The communication application 120 may include any application that enables a user to send and/or receive electronic communications. For example, the communication application 120 may communicate with the communication server system 140 to send one or more electronic communications from the communication server system 140 that are intended for one or more other parties to view, including content addressed to another party and/or published content that is accessible to the other party. For example, one or more electronic communication/s may be addressed to an email address, phone number, account, handle, or other contact identifier of the other party. As an alternative and/or addition, one or more electronic communications may be accessible to the public and/or an account of the other party.

As used herein, the term “electronic communication” refers to any digital message comprising digital content intended for a party to view or otherwise consume, such as emails, events, notifications, invitations, social media messages and/or posts, other social media content, message board posts and/or content, direct messages, Short Message Service (SMS) communications, Multimedia Messaging Service (MMS) communications, Rich Communications Services (RCS) communications, iMessage™ communications, other instant messaging communications, collaboration tool communications, voice messages, video messages, and/or any other electronic communication intended for a party to view. In some embodiments, the electronic communications may include one or more of image content, audio content, video content, streaming content, real-time and/or recorded media content, attached digital content, code content, webpage content, and/or any other form of digital content intended for a party to view.

In some embodiments, the communication application 120 is a native application developed for use on a particular operating system, platform, and/or device, such as Microsoft Outlook^{®} for Desktop (e.g., Windows^{®}, Mac^{®}) and Microsoft OutlookMobile (e.g., Android^{®}, iOS^{®}). As an alternative, the communication application 120 may be a web application such as Outlook on the Web (OWA), an extension, a plug-in, a cross-platform application, a hybrid application, and/or any other application that enables the user to send and/or receive electronic communications.

In some embodiments, the electronic communications comprise emails. For example, the communication application 120 may comprise an email client, such as Microsoft Outlook. As an alternative and/or addition, the communication server system 140 may comprise an email server, such as a Microsoft Exchange Server^{®}. For example, the communication application 120 may be configured to send and receive emails for an email address of the user via a Microsoft Exchange Server. One or more embodiments described herein may refer to emails, email clients, and/or email servers, but are not limited thereto. That is, such embodiments may be adapted to any electronic communication, communication application, and/or communication server system without departing from the spirit and or/the scope of this disclosure.

### COMMUNICATION MONITORING SYSTEM

The communication monitoring system 110 evaluates electronic communications generated at the user computing device 130 based on observational data, such as interaction data obtained at the user computing device 130. The interaction data may correspond to one or multiple users that interact with the user computing device 130. The term “user” may apply to an individual who uses the user computing device 130, one or more applications executing on the user computing device 130, and/or one or more communication accounts and/or addresses.

The communication monitoring system 110 may be implemented as one or more native applications, web applications, extensions, plug-ins, cross-platform applications, hybrid applications, and/or any other application executing on the user computing device 130. In some embodiments, the communication monitoring system 110 is at least partially implemented using an integration framework of the communication application 120. For example, the communication monitoring system 110 may be at least partially implemented as an add-in to Outlookusing the Outlook add-in framework, allowing it to extend the functionality of an Outlookcommunication application 120. As an alternative and/or addition, the communication monitoring system 110 may be at least partially implemented as a plug-in of a browser application that executes one or more communication applications 120 as web application/s.

In some embodiments, the communication monitoring system 110 includes an observational data monitoring system 102, an observational data processing system 104, and a validation system 106. The communication monitoring system 110 and/or its components (e.g. observational data monitoring system 102, observational data processing system 104, and/or validation system 106) are presented herein as individual components for ease of explanation; the communication monitoring system 110 and/or its components may be implemented as one or more dependent or independent processes and/or programs, and may be implemented on one or multiple computers. For example, one or more components may be implemented as a distributed system. As an alternative and/or addition, multiple instances of one or more components may be implemented. Any action performed by or to one or more components of the communication monitoring system 110 may be considered performed by or to the communication monitoring system 110.

### OBSERVATIONAL DATA

The observational data monitoring system 102 is configured to monitor, identify, and/or obtain observational data, such as interaction data, environmental data, platform data, and other observational data. As used herein, the term “observational data” refers to any data that can be obtained by monitoring or otherwise observing one or more subjects and/or processes. Observational data may include raw observational data in the form that it was originally collected and/or processed observational data. In some embodiments, the observational data monitoring system 102 comprises one or more background processes configured to monitor and/or obtain observational data generated on the user computing device 130. As an alternative and/or addition, the observational data monitoring system 102 may be at least partially implemented using an integration framework of the communication application 120.

Observational data may be obtained and/or monitored in real time. For example, observational data may be processed in real-time to detect the sending of an electronic communication. As an alternative and/or addition, observational data may be stored, processed, aggregated, and/or analyzed. For example, observational data may be used to determine typical behavior and/or other parameters, generate and/or maintain a user profile, develop one or more predictive models, detect new malicious behavioral patterns, determine a risk level of an electronic communication, and/or other purposes.

In some embodiments, observational data includes interaction data. As used herein, the term "interaction data" refers to any data describing user interactions with the user computing device 130, including its applications, systems, interfaces, connected devices, and/or other aspects of the user computing device 130. For example, interaction data may include data describing inputs from one or more I/O devices belonging to and/or communicatively connected with the user computing device 130, such as keystrokes, mouse movements, clicks, touch, gestures, and/or other inputs from one or more keyboards, mice, touchscreens, trackpads, styluses, microphones, cameras, and/or other I/O devices. As an alternative and/or addition, interaction data may include interactions with software elements, such as interactive components of application user interfaces (UIs). For example, interaction data may include user interactions with the communication application 120, such as opening the communication application 120, composing an electronic communication, interacting with a user interface of the communication application 120 such as a graphical user interface (GUI) and/or a command line interface (CLI), opening an incoming electronic communication, opening an outgoing electronic communication, creating a new electronic communication, opening a draft electronic communication, keystrokes or other input resulting in the generation of one or more portions of an electronic communication, sending an electronic communication, otherwise triggering commands in the communication application 120, and/or other interactions with the communication application 120. Interaction data may include data describing one or more parameters of such interactions, such as time, speed, velocity, frequency, and/or any other characteristic of one or more user interactions.

As an alternative and/or addition, observational data may include environmental data. As used herein, the term "environmental data" refers to any data describing the environment surrounding or associated with the user computing device 130. For example, environmental data may include data obtained from one or more sensors belonging to and/or communicatively connected with the user computing device 130, such as one or more temperature sensors, humidity sensors, barometers, light sensors, air quality sensors, accelerometers, gyroscopes, magnetometers, GPS receivers, cameras, microphones, fingerprint readers, biometric sensors, and/or other sensors. Interaction data may include data describing one or more parameters of such interactions, such as time, speed, velocity, frequency, and/or any other descriptive characteristic. Environmental data may include data describing one or more parameters of such environmental conditions, including time, changes over time, frequency, intensity, and/or any other characteristic of one or more environmental conditions.

As an alternative and/or addition, observational data may include platform data. As used herein, the term "platform data" refers to any data describing the state, configuration, usage, performance, and/or other property of the user computing device 130, including connected devices, applications, systems, and/or other aspects of the user computing device 130. For example, platform data may include computing resource usage statistics, applications installed, operating system/s (OS) installed, installation dates, application runtime duration, and/or other data describing a property of the user computing device 130. In some embodiments, the platform data may include properties corresponding to specific applications and/or application types. For example, the platform data may include properties corresponding to one or more specific communication applications 120. As an alternative and/or addition, the platform data may include properties corresponding to one or more specific security software applications, such as antivirus software, antimalware software, spam blockers, anti-phishing software, endpoint protection platform (EPP) software, intrusion detection/prevention systems, firewall software, virtual private network (VPN) software, and/or other security software. Platform data may include data describing one or more parameters of such device properties, including time, changes over time, frequency, and/or any other characteristic of one or more device properties.

The observational data monitoring system 102 may be configured to monitor observational data generated at the user computing device 130 in order to obtain observational data that is relevant to determining a risk level of one or more electronic communications sent from the user computing device 130. In some embodiments, the observational data monitoring system 102 is configured to obtain observational data in accordance with one or more configuration resources 112. The configuration resource/s 112 may include one or more settings, rules, computer-executable instructions, formulas, parameters, templates, models, and/or other configuration information describing the obtaining of observational data. In some embodiments, the configuration resources 112 include one or more models generated based on machine learning techniques. As an alternative and/or addition, the configuration resources 112 may include one or more large language models (LLMs).

### PROCESSING OBSERVATIONAL DATA

The observational data processing system 104 is configured to process and/or analyze observational data obtained on the user computing device 130. For example, the observational data processing system 104 may process observational data obtained by the observational data monitoring system 102. Processing may include filtering, normalizing, classifying, transforming, aggregating, anonymizing, compressing, encrypting, serializing, encoding, validating, and/or otherwise processing the observational data. In some embodiments, observational data relevant to determining a risk level of one or more electronic communications may be processed to generate signal data, which may be considered a form of observational data. The signal data may have been processed to remove sensitive data. Unless explicitly specified, any reference to observational data and/or signal data with respect to data analysis and/or validation of electronic communications may be interchangeable without departing from the spirit or the scope of the disclosure.

The signal data may include observational data that is relevant to determining a risk level of one or more electronic communications sent from the user computing device 130. For example, the signal data may include processed observational data of one or more types described herein, including the processing of two or more pieces of observational data to generate signal data. In some embodiments, processing may include filtering, normalizing, classifying, transforming, aggregating, or otherwise processing observational data. In some embodiments, signal data may reflect observational data comprising interaction data describing user inputs detected during the drafting of an electronic communication. As an alternative and/or addition, the signal data may reflect observational data comprising platform data describing the presence of evasion techniques known to be performed by malicious software. As an alternative and/or addition, the signal data may reflect observational data comprising environmental data describing incidental movement of the user computing device 130. As an alternative and/or addition, the signal data may include an output of one or more models generated based on machine learning techniques applied to observational data.

In some embodiments, the observational data processing system 104 is configured to process observational data in accordance with one or more settings, rules, computer-executable instructions, formulas, parameters, templates, models, and/or any other configuration information. For example, the observational data processing system 104 may be configured to process observational data in accordance with one or more configuration resources 112 comprising one or more settings, rules, computer-executable instructions, formulas, parameters, templates, models, and/or other configuration information describing the processing of observational data. In some embodiments, the configuration resources 112 include one or more models generated based on machine learning techniques. As an alternative and/or addition, the configuration resources 112 may include one or more large language models (LLMs).

In some embodiments, the observational data processing system 104 may be configured to maintain a device score for the user computing device 130 based on observational data collected on the user computing device 130. As an alternative and/or addition, the device score for the user computing device 130 may be based on historical risk levels for electronic communications sent from the user computing device 130. As an alternative and/or addition, the device score for the user computing device 130 may be based on additional observational data not associated with the sending of a particular electronic communication. When determining the risk level of an electronic communication after a send command is detected on the user computing device 130, the risk level may be based on the device score for the user computing device 130.

In some embodiments, the observational data processing system 104 may be configured to maintain a user score based on observational data collected on one or more user computing devices used by the user. As an alternative and/or addition, the user score may be based on historical risk levels for electronic communications sent from an account of the user. As an alternative and/or addition, the user score may be based on additional observational data not associated with the sending of a particular electronic communication. When determining the risk level of an electronic communication after a send command is detected on the user computing device 130, the risk level may be based on the user score associated with the corresponding account.

### VALIDATING ELECTRONIC COMMUNICATIONS

The communication monitoring system 110 is configured to evaluate the risk level of electronic communications sent from the user computing device 130. In some embodiments, the communication monitoring system 110 detects a command or other action to send an electronic communication from the user computing device 130. For example, the validation system 106 may the validation system 106 associates a vag in the communication application 120. In some embodiments, the command may be detected based on observational data obtained on the user computing device, such as but not limited to interaction data. For example, the observational data processing system 104 may identify user input obtained by the observational data monitoring system 102 that initiates a command to send an electronic communication from the communication application 120.

After the command to send an electronic communication is detected, the validation system 106 of the communication monitoring system 110 determines a risk level of the particular electronic communication based on observational data, such as signal data and/or other observational data. The risk level of the electronic communication may correspond to the likelihood that electronic communication is not generated by a human user. As an alternative and/or addition, the risk level of the electronic communication may take other factors into account regarding the risk level of the electronic communication. The risk level is determined based on observational data, such as interaction data, environmental data, platform data, and/or other observational data.

In some embodiments, the validation system 106 is configured to validate electronic communications in accordance with one or more settings, rules, computer-executable instructions, formulas, parameters, templates, models, and/or any other configuration information. For example, the validation system 106 may be configured to validate electronic communications in accordance with one or more configuration resources 112 comprising one or more settings, rules, computer-executable instructions, formulas, parameters, templates, models, and/or other configuration information describing the validation of electronic communications. In some embodiments, the configuration resources 112 include one or more models generated based on machine learning techniques. As an alternative and/or addition, the configuration resources 112 may include one or more large language models (LLMs).

In some embodiments, the validation system 106 determines the risk level at the user computing device 130. As an alternative and/or addition, the validation server system 106 may obtain the risk level from the validation server system 160, such as by submitting a request comprising relevant observational data to the validation server system 160. The request may include relevant observational data that has been anonymized, deidentified, aggregated, tokenized, encrypted, filtered, and/or otherwise processed.

When the risk level of the electronic communication is below a risk threshold, the validation system 106 associates a validation indicator with an electronic communication after determining that the risk level of the electronic communication is below a risk threshold. For example, the risk level may correspond to the likelihood that the electronic communication is not generated by a human user. A validation indicator may be any data that serves as an indication of the determination. The association is made available to another system configured to use the validation indicator, such as a communication server system (e.g., communication server system 140, 340), a detection server system (e.g., detection server system 342) and/or a fraud prevention application (e.g., fraud prevention applications 370-372). The usage of the validation indicator is described in greater detail hereinafter.

In some embodiments, the validation system 106 generates the validation indicator at the user computing device 130. As an alternative and/or addition, the validation server system 106 may obtain the validation indicator from the validation server system 160. The communication monitoring system 110 may associate the validation indicator with a corresponding electronic communication by modifying the electronic communication to include the validation indicator.

In some embodiments, the validation indicator is a digital signature. For example, associating the validation indicator with the electronic communication may include signing the electronic communication before allowing the sending of the electronic communication to proceed. Signing the electronic communication indicates that the communication monitoring system 110 has determined that the risk level of the electronic communication is below the risk threshold, such as by analyzing interaction data and/or other observational data. For example, the validation system 106 may sign the electronic communication by generating a digital signature comprising encrypted data that verifies the authenticity and/or integrity of the electronic communication, the sender, the validation process, or other aspects. In some embodiments, the validation system 106 generates the digital signature by encrypting data corresponding to the electronic communication, such as but not limited to a hash, with a private key. A fraud prevention application 372-370 may use the corresponding public key to verify that the item is unaltered and that the validation was performed by the communication monitoring system 110. In some embodiments, the validation indicator comprises the digital signature.

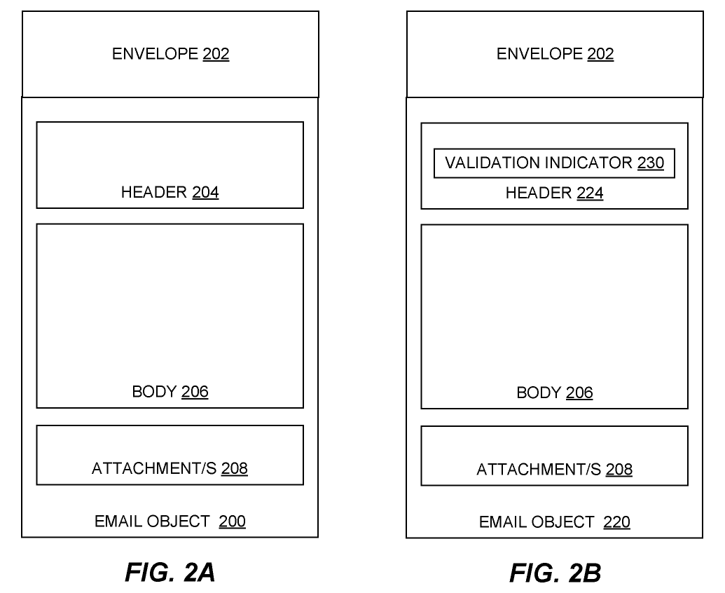

In some embodiments, associating the validation indicator may include adding the validation indicator to metadata of the electronic communication, as shown in the example email of FIGS. 2A-2B.

FIG. 2A illustrates an email object in an example embodiment. The envelope 202 of the email object 200 includes routing information, such as the sender’s and recipient’s addresses, which are used by mail servers involved in the email's transmission to ensure proper delivery of the email object 200 to the intended recipient. The envelope 202 exists during the transmission of the email object 200. The header 204 of the email object 200 includes metadata associated with the email, such as sender and recipient information, time information, routing information, content descriptions, security and authentication information, and/or other metadata associated with the email. The body 206 of the email object 200 includes the message content intended by the sender. For example, the body 206 may include text, images, links, and the like. The email object 200 may optionally include one or more attachments 208, which are files or documents appended to the email for transmission along with the body 206.

FIG. 2B illustrates an email object comprising a validation indicator in an example embodiment. The email object 220 of FIG. 2B is a version of the email object 200 of FIG. 2A at a later point in time, and the header 224 is a version of the header 204 of the email object 200 at the later point in time. For example, after a communication monitoring system 110 determines that the risk level of the email object 200 is below a risk threshold, the communication monitoring system 110 may add the validation indicator 230 to the header 224 of the email object 220. In some embodiments, the validation indicator 230 comprises a digital signature, and the communication monitoring system 110 signs the email object 220 by adding the validation indicator 230 to the header 224. When the risk level of the electronic communication is below the risk threshold, the communication monitoring system 110 may allow sending of the electronic communication to proceed.

When the risk level of electronic communication is above the risk threshold, the communication monitoring system 110 may allow sending of the electronic communication to proceed without associating any validation indicator with the electronic communication. As an alternative and/or addition, when the risk level of the electronic communication is above the risk threshold, the communication monitoring system 110 may perform a mitigating action. For example, the communication monitoring system 110 may prevent the electronic communication from being sent. As an alternative and/or addition, when the risk level of the electronic communication is above the risk threshold, the communication monitoring system 110 may send a notification to a monitoring entity indicating that the user computing device 130 is likely compromised. For example, when the communication server system 140 is deployed in an enterprise computer system comprising one or more physical and/or virtual computer systems that are owned by and/or under the control of an enterprise customer, the communication monitoring system 110 may send the electronic notification to an administrator and/or other individual associated with the enterprise customer.

### VALIDATION SERVER SYSTEM

In some embodiments, the computer system 100 includes a validation server system 160 configured to support the communication monitoring system 110. For example, the validation server system 160 may support multiple instances of a communication monitoring application comprising the communication monitoring system 110, such as a plurality of instances executing on a plurality of user computing devices 130. In some embodiments, the validation server system 160 provides downloads and/or updates corresponding to the communication monitoring application.

As an alternative and/or addition, the validation server system 160 may obtain data from individual instances of the communication monitoring system 110 for analysis. The communication monitoring system 110 instances may anonymize, deidentify, aggregate, tokenize, encrypt, filter, and/or otherwise process data at the respective user computing device 130 to prevent or minimize the collection of sensitive data by the validation server system 160.

In some embodiments, the validation server system 160 may analyze observational data corresponding to individual electronic communications in order to determine a risk level of the individual electronic communications. For example, a validation system 106 of the user computing device 130 may submit observational data corresponding to an individual electronic communication to the validation server system 160. The submitted observational data may comprise signal data and/or relevant observational data, which may have been anonymized, deidentified, aggregated, tokenized, encrypted, filtered, and/or otherwise processed. The validation server system 160 may determine the risk level of the individual electronic communication based on the submitted observational data. The validation server system 160 may provide the risk level of the individual electronic communication to the requesting validation system 106. In some embodiments, the validation server system 160 may generate and/or provide a validation indicator corresponding to the individual electronic communication to the requesting validation system 106.

As an alternative and/or addition, the validation server system 160 may analyze data from a plurality of instances of the communication monitoring system 110 to generate one or more settings, rules, computer-executable instructions, formulas, parameters, templates, models, and/or any other validation resource usable by the communication monitoring system 110 to control, modify, and/or otherwise configure the operation of the communication monitoring system 110. In some embodiments, the validation server system 160 generates one or more models based on machine learning techniques. As an alternative and/or addition, the validation server system 160 may generate one or more large language models (LLMs).

As an alternative and/or addition, the validation server system 160 may analyze data from a plurality of instances of the communication monitoring system 110 to generate one or more configuration resources 112. In some embodiments, the system 160 distributes new and/or updated configuration resources 112 to the communication monitoring system 110 instances, such as to control, modify, and/or otherwise configure the operation of the communication monitoring system 110 instances.

### FRAUD PREVENTION SYSTEM IN A NETWORK ENVIRONMENT

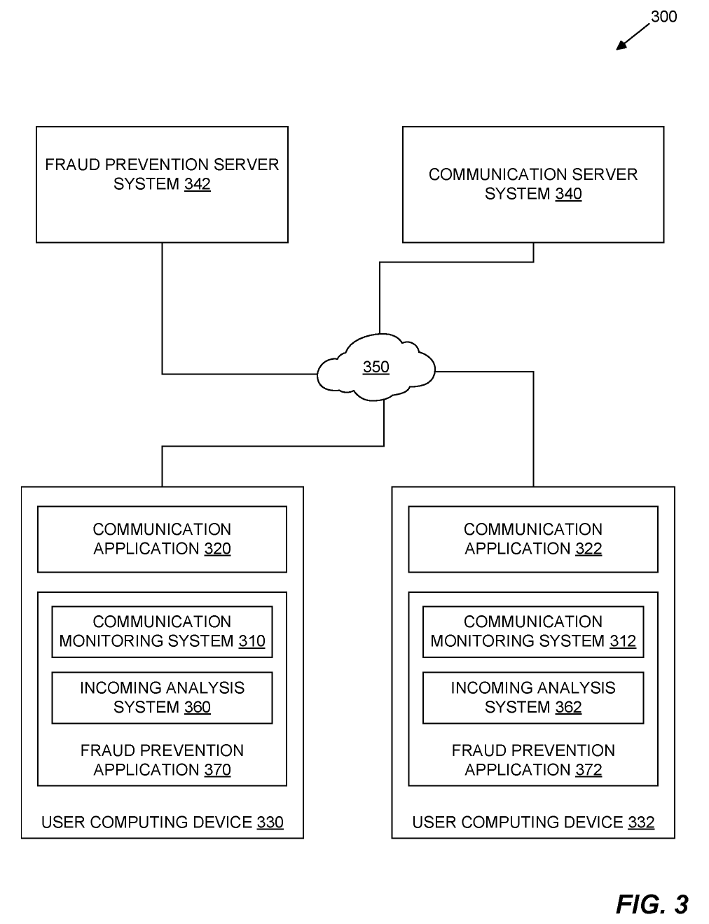

In some embodiments, the communication monitoring system 110 is a component of a fraud prevention system configured to detect fraudulent electronic communications on one or more user computing devices. FIG. 3 illustrates a computer system that includes a communication server system, a user computing device that sends an electronic communication, and a user computing device that receives the electronic communication in an example embodiment. The computer system 300 includes a communication server system 340, a fraud prevention server system 342, a first user computing device 330, and a second user computing device 332. The fraud prevention system includes the fraud prevention server system 342 and the fraud prevention applications 370-372. While a specific configuration is shown, the computer system 300 may be adapted to include additional server systems, additional communication applications, and/or additional user computing devices without departing from the spirit or the scope of this disclosure. The fraud prevention server system 342, communication server system 340, and the user computing devices 330-332 may communicate over a network 350, which may include one or more local area networks (LANs) and/or one or more wide area networks, such as the Internet.

A first fraud prevention application 370 and a first communication application 320 execute on the first user computing device 330. A second fraud prevention application 372 and a second communication application 322 execute on the second user computing device 332. In some embodiments, the fraud prevention applications 370-372 are different instances of the same fraud prevention software, and/or the communication applications 320-322 are different instances of the same communication software, which may include the same version or different versions of the respective software. The fraud prevention server system 342 may include one or more server systems that provide server functionality corresponding to one or more aspects of the fraud prevention applications 370-372. The fraud prevention server system 342 may include one or more server systems that provide server functionality corresponding to one or more aspects of the communication applications 320-322.

The fraud prevention applications 370-372 include respective communication monitoring systems 310-312. The fraud prevention applications 370-372 may also include respective incoming analysis systems 360-362. In some embodiments, each incoming analysis system 360-362 is configured to detect fraudulent electronic communications, such as fraudulent content produced using generative artificial intelligence (AI). For example, each incoming analysis system 360-362 may be configured to notify a respective user regarding fraudulent electronic communications as the respective user interacts with electronic communications on the respective user computing device 330-332. Example incoming analysis systems are described in greater detail in U.S. Patent App. No. ______, filed _____, the entire contents of which are hereby incorporated by reference as if fully set forth herein.

In some embodiments, the communication monitoring systems 310-312 are configured to evaluate the risk level of electronic communications sent from the respective user computing devices 330-332. For example, the communication monitoring systems 310-312 may detect a command or other action to send an electronic communication from a respective communication application 320-322, determine a risk level of the electronic communication, and associate a validation indicator with the electronic communication after determining that a risk level of electronic communication is below a risk threshold.

In some embodiments, the fraud prevention applications 370-372 evaluate incoming electronic communications received by the respective user computing devices 330-332. For example, a respective communication application 320-322 may receive an electronic communication. The fraud prevention applications 370-372 may be configured to obtain electronic communication content corresponding to the incoming electronic communication. When the incoming electronic communication is associated with a validation indicator, the fraud prevention applications 370-372 may determine that the risk level of the incoming electronic communication is low based at least in part on verifying the validation indicator associated with the incoming electronic communication.

In some embodiments, the communication server system 340 may be deployed in an enterprise system comprising one or more physical and/or virtual computer systems that are owned by and/or under the control of an enterprise customer of the fraud prevention system. The users of the user computing devices 330-332 are associated with the enterprise customer, such as by having electronic communication accounts managed by the communication server system 340 of the enterprise customer. The validation of electronic communications between the users associated with the enterprise customer protects the enterprise customer from fraudulent activity involving automated electronic communications on the user computing devices 330-332 associated with the enterprise customer. For example, when a first user computing device 330 associated with the enterprise customer is compromised by malicious software configured to facilitate fraudulent activity, the corresponding communication monitoring system 360 will not validate automated electronic communications generated by the malicious software on the first user computing device 330.

In some embodiments, when a second user computing device 332 associated with the enterprise customer receives an electronic communication sent from the first user computing device 330 that is validated, the incoming analysis system 362 will give the electronic communication a higher level of trust compared to unvalidated electronic communications. Giving the electronic communication a higher level of trust may include whitelisting validated electronic communications, applying a presumption that the electronic communication is generated by a human user, applying a lower level of scrutiny to the electronic communication, subjecting the electronic communication to fewer fraud detection tests, and/or otherwise giving the electronic communication a higher level of trust when detecting fraudulent electronic communications on the second user computing device 332.

In some embodiments, the second user computing device 332 that receives the electronic communication is not associated with the same enterprise customer, but is associated with a second enterprise customer of the fraud detection system. In this case, the incoming analysis system 362 may give the electronic communication a higher level of trust compared to unvalidated electronic communications. The validation of electronic communications between the users of different enterprise customers may be mutually beneficial, and both enterprise customers may be protected from fraudulent activity.

In some embodiments, when a second user computing device 332 associated with the enterprise customer receives an unvalidated electronic communication sent from the first user computing device 330, the incoming analysis system 362 will not treat the unvalidated electronic communication with a higher level of trust. As an alternative and/or addition, the second user computing device 332 may expect electronic communications to be validated when received from a sender associated with customers of the fraud detection system, and may give unvalidated electronic communications from such senders a lower level of trust compared to unvalidated electronic communications from senders that are not associated with a customer of the fraud detection system. Giving the electronic communication a lower level of trust may include blocking and/or flagging unvalidated electronic communications associated with the customers of the fraud detection system, applying a presumption that the electronic communication is not generated by a human user, applying a higher level of scrutiny to the electronic communication, subjecting the electronic communication to more fraud detection tests, and/or otherwise giving the electronic communication a lower level of trust when detecting fraudulent electronic communications on the second user computing device 332.

In some embodiments, a user computing device that receives an electronic communication sent from the first user computing device 330 is not associated with any customer of the fraud prevention system, and does not execute any instance of the fraud prevention application. The validation indicator may be configured such that it does not interfere with the viewing and/or other processing of the electronic communication.

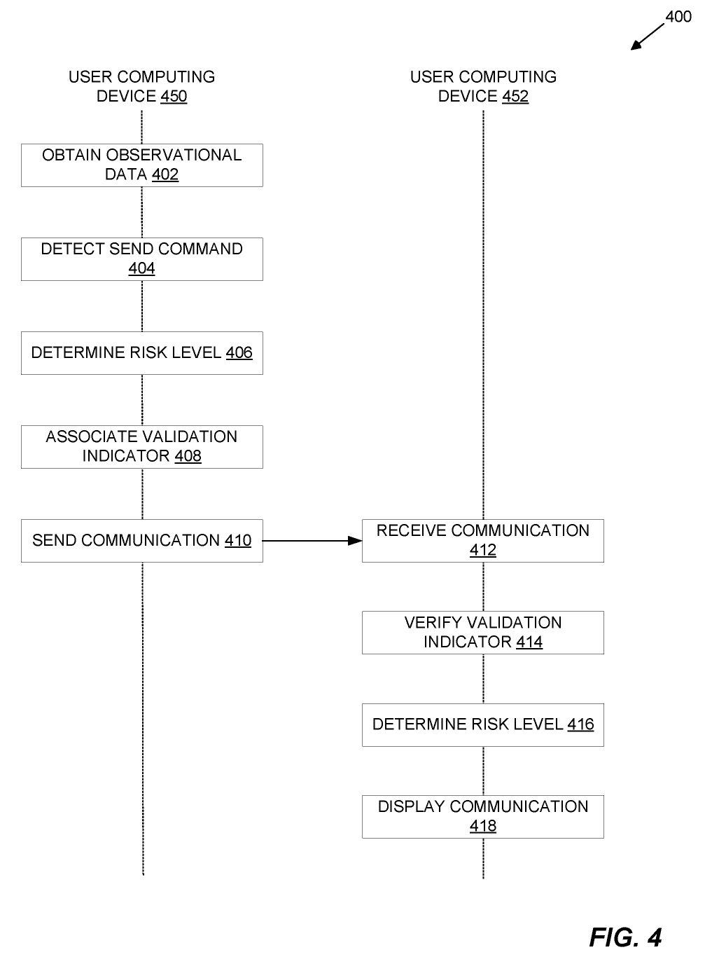

FIG. 4 is a swimlane diagram of a process for sending and receiving a validated electronic communication in an example embodiment. Process 400 may be performed by one or more computing devices and/or processes thereof. For example, process 400 may be performed in the context of the computer system 300 of FIG. 3. Process 400 will be described with a sending user computing device 330 and a receiving user computing device 332 of FIG. 3, but is not limited to performance in this context.

At block 402, the communication monitoring system 310 of the sending user computing device 330 obtains observational data, including interaction data between the user and the communication application 320. At block 404, the communication monitoring system 310 detects a command on the sending user computing device 330 to send an electronic communication via the communication application 320. At block 406, the communication monitoring system 310 determines a risk level of the electronic communication. At block 408, when the risk level of the electronic communication is below a risk threshold, the communication monitoring system 310 associates a validation indicator with the electronic communication and allows sending of the electronic communication from the communication application 320 to proceed. At block 410, the communication application 320 of the sending user computing device 330 sends the electronic communication. In some embodiments, the electronic communication may be sent with or without a validation indicator.

At block 412, the communication application 322 of the receiving user computing device 332 receives electronic communication. At block 414, the incoming analysis system 362 of the receiving user computing device 332 determines that a validation indicator is associated with the electronic communication and verifies the validation indicator. At block 416, the incoming analysis system 362 determines a risk level of the electronic communication based at least in part on the validation indicator. For example, electronic communications comprising a verified validation indicator may be subject to a lower level of scrutiny, and may generally be determined to have a low risk level when other high-risk factors are not present. At block 418, the receiving user computing device 332 displays the electronic communication based on the risk level of the electronic communication. For example, when the risk level is below a risk threshold, the communication application 322 of the receiving user computing device 332 may display the electronic communication without any notifications, flags, or other warnings.

### EXAMPLE PROCESSES

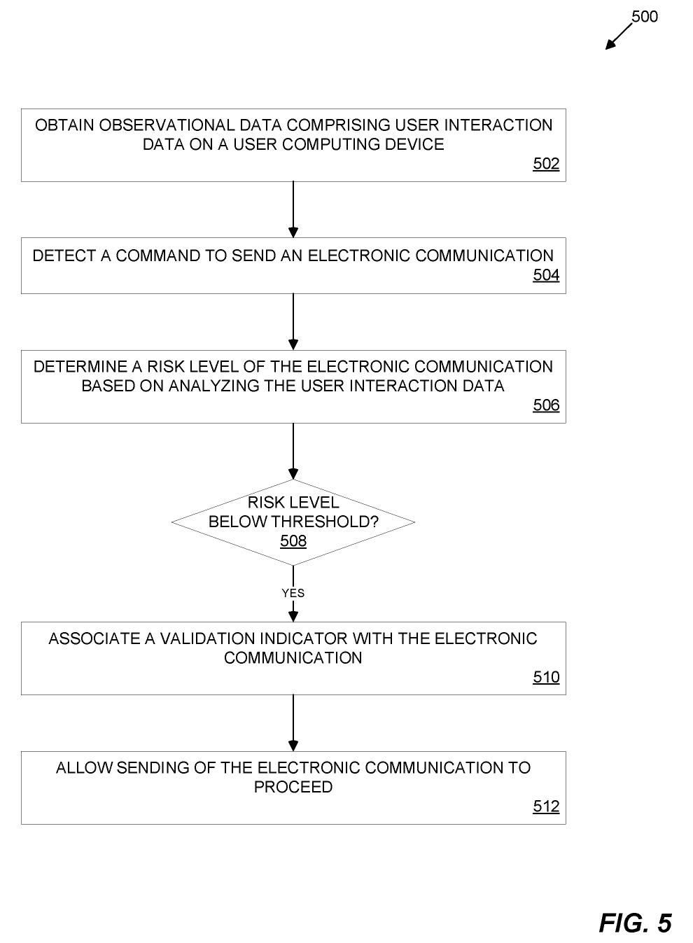

FIG. 5 is a flow diagram of a process for evaluating electronic communications based on interaction data in an example embodiment. Process 500 may be performed by one or more computing devices and/or processes thereof. For example, one or more blocks of process 500 may be performed by a computer system, such as computer system 600. In some embodiments, one or more blocks of process 500 are performed by a communication monitoring system, such as communication monitoring system 110. Process 500 will be described with respect to communication monitoring system 110, but is not limited to performance by communication monitoring system 110.

At block 502, the communication monitoring system 110 obtains observational data comprising interaction data on a user computing device. In some embodiments, the observational data further comprises environmental data. As an alternative and/or addition, the observational data further comprises platform data.

At block 504, the communication monitoring system 110 detects a command to send an electronic communication on the user computing device. For example, the communication monitoring system 110 may detect the command in a communication application executing on the user computing device. In some embodiments, the electronic communication is an email.

At block 506, the communication monitoring system 110 determines a risk level of the electronic communication based on analyzing the interaction data. The risk level corresponds to a likelihood that the electronic communication is not generated by a human user. In some embodiments, determining the risk level of the electronic communication is based on the environmental data. As an alternative and/or addition, determining the risk level of the electronic communication is based on the platform data.

At decision block 508, the communication monitoring system 110 determines whether the risk level of the electronic communication is below a risk threshold. When the risk level of the electronic communication is below the risk threshold, processing continues to block 510. In some embodiments, when the risk level of the electronic communication is not below the risk threshold, the communication monitoring system 110 performs a mitigating action (not shown). For example, the communication monitoring system 110 may prevent the electronic communication from being sent. As an alternative and/or addition, the communication monitoring system 110 may send a notification to monitoring entity indicating that the user computing device is compromised.

At block 510, the communication monitoring system 110 associates a validation indicator with the electronic communication. In some embodiments, associating the validation indicator with the electronic communication comprises signing the electronic communication before allowing the sending of the electronic communication to proceed. As an alternative and/or addition, associating the validation indicator comprises adding the validation indicator to metadata of the electronic communication.

At block 512, the communication monitoring system 110 allows sending of the electronic communication to proceed.

### IMPLEMENTATION MECHANISMS—HARDWARE OVERVIEW

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field-programmable gate arrays (FPGAs) that are persistently programmed to perform the techniques. Alternatively and/or in addition, the one or more special-purpose computing devices may include one or more general-purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, and/or any other device that incorporates hard-wired or program logic to implement the techniques.

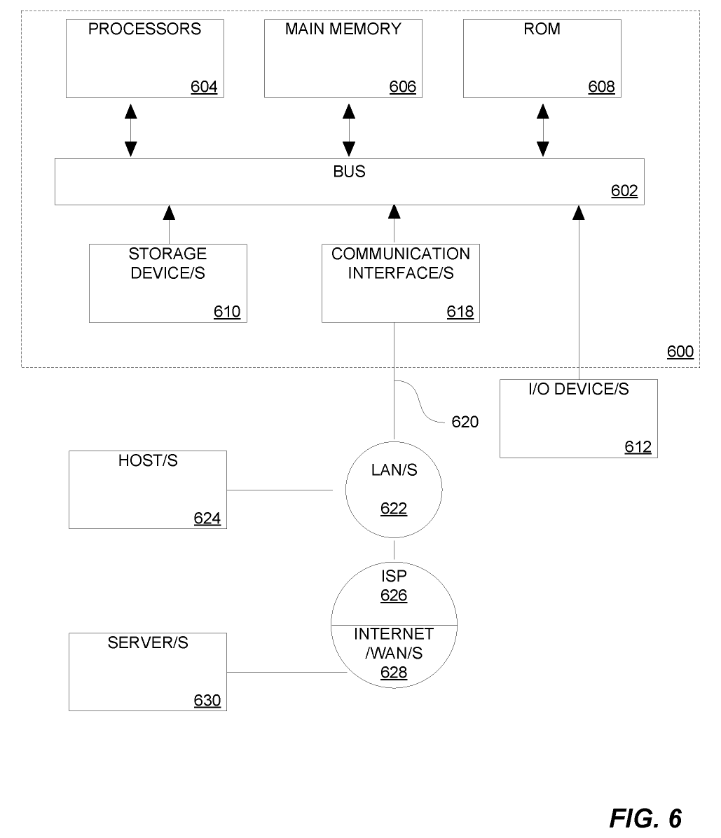

FIG. 6 illustrates a computer system 600 upon which one or more embodiments described herein may be implemented. The computer system 600 includes a bus 602 or another communication mechanism for communicating information, and one or more hardware processors 604 coupled with bus 602 for processing information, such as computer instructions and data. The hardware processor/s 604 may include one or more general-purpose microprocessors, graphical processing units (GPUs), coprocessors, central processing units (CPUs), and/or other hardware processing units. As an alternative or addition, one or more computer systems 600 may be configured to provide a cloud computing environment, virtual machine, and/or other software-based emulation of a physical computing environment upon which one or more embodiments described herein may be implemented.

The computer system 600 also includes one or more units of main memory 606 coupled to the bus 602, such as random-access memory (RAM) or other dynamic storage, for storing information and instructions to be executed by the processor/s 604. Main memory 606 may also be used for storing temporary variables or other intermediate information during execution of instructions to be executed by the processor/s 604. Such instructions, when stored in non-transitory storage media accessible to the processor/s 604, turn the computer system 600 into a special-purpose machine that is customized to perform the operations specified in the instructions. In some embodiments, main memory 606 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

The computer system 600 may further include one or more units of read-only memory (ROM) 608 or other static storage coupled to the bus 602 for storing information and instructions for the processor/s 604 that are either always static or static in normal operation but reprogrammable. For example, the ROM 608 may store firmware for the computer system 600. The ROM 608 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 610, such as a magnetic disk or optical disk, is provided and coupled to the bus 602 for storing information and/or instructions. The storage device/s 610 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid-state drives, flash memory, optical disks, one or more forms of non-volatile random-access memory (NVRAM), and/or other non-volatile storage media.

The computer system 600 may be coupled via the bus 602 to one or more input/output (I/O) devices 612. For example, the I/O device/s 612 may include one or more displays for displaying information to a computer user, such as a cathode ray tube (CRT) display, a Liquid Crystal Display (LCD) display, a Light-Emitting Diode (LED) display, a projector, and/or any other type of display.

The I/O device/s 612 may also include one or more input devices, such as an alphanumeric keyboard and/or any other keypad device. The one or more input devices may also include one or more cursor control devices, such as a mouse, a trackball, a touch input device, or cursor direction keys for communicating direction information and command selections to the processor 604 and for controlling cursor movement on another I/O device (e.g. a display). A cursor control device typically has at degrees of freedom in two or more axes, (e.g. a first axis x, a second axis y, and optionally one or more additional axes z), that allows the device to specify positions in a plane. In some embodiments, the one or more I/O device/s 612 may include a device with combined I/O functionality, such as a touch-enabled display.

Other I/O device/s 612 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with the processor/s 604 over the bus 602.

The computer system 600 may implement the techniques described herein using customized hard-wired logic, one or more ASICs or FPGAs, firmware, and/or program logic that causes computer system 600 to be a special-purpose machine. According to one embodiment, the techniques herein are performed by the computer system 600 in response to the processor/s 604 executing one or more sequences of one or more instructions contained in main memory 606. Such instructions may be read into main memory 606 from another storage medium, such as the one or more storage device/s 610. Execution of the sequences of instructions contained in main memory 606 causes the processor/s 604 to perform the process steps described herein. In alternative embodiments, hard-wired circuitry may be used in place of or in combination with software instructions.

The computer system 600 also includes one or more communication interfaces 618 coupled to the bus 602. The communication interface/s 618 provide two-way data communication over one or more physical or wireless network links 620 that are connected to a local network 622 and/or a wide area network (WAN), such as the Internet. For example, the communication interface/s 618 may include an integrated services digital network (ISDN) card, cable modem, satellite modem, or a modem to provide a data communication connection to a corresponding type of telephone line. Alternatively and/or in addition, the communication interface/s 618 may include one or more of: a local area network (LAN) device that provides a data communication connection to a compatible local network 622; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network; and other networking devices that establish a communication channel between the computer system 600 and one or more LANs 622 and/or WANs.

The network link/s 620 typically provides data communication through one or more networks to other data devices. For example, the network link/s 620 may provide a connection through one or more local area networks 622 (LANs) to one or more host computers 624 or to data equipment operated by an Internet Service Provider (ISP) 626. The ISP 626 provides connectivity to one or more wide area networks 628, such as the Internet. The LAN/s 622 and WAN/s 628 use electrical, electromagnetic, or optical signals that carry digital data streams. The signals through the various networks and the signals on the network link/s 620 and through the communication interface/s 618 are example forms of transmission media or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire, and fiber optics, including traces and/or other physical electrically conductive components that comprise the bus 602. Transmission media can also take the form of acoustic or light waves, such as those generated during radio-wave and infrared data communications.

Various forms of media may be involved in carrying one or more sequences of one or more instructions to the processor 604 for execution. For example, the instructions may initially be carried on a magnetic disk or solid-state drive of a remote computer. The remote computer can load the instructions into its main memory 606 and send the instructions over a telecommunications line using a modem. A modem local to the computer system 600 can receive the data on the telephone line and use an infrared transmitter to convert the data to an infrared signal. An infra-red detector can receive the data carried in the infra-red signal and appropriate circuitry can place the data on the bus 602. The bus 602 carries the data to main memory 606, from which the processor 604 retrieves and executes the instructions. The instructions received by main memory 606 may optionally be stored on the storage device 610 either before or after execution by the processor 604.

The computer system 600 can send messages and receive data, including program code, through the network(s), the network link 620, and the communication interface/s 618. In the Internet example, one or more servers 630 may transmit signals corresponding to data or instructions requested for an application program executed by the computer system 600 through the Internet 628, ISP 626, local network 622 and a communication interface 618. The received signals may include instructions and/or information for execution and/or processing by the processor/s 604. The processor/s 604 may execute and/or process the instructions and/or information upon receiving the signals by accessing main memory 606, or at a later time by storing them and then accessing them from the storage device/s 610.

### OTHER ASPECTS OF DISCLOSURE

Although the concepts herein have been described with reference to particular embodiments, it is to be understood that these embodiments are merely illustrative of the principles and applications of the present disclosure. Unless otherwise specified, descriptions of individual elements depicted in one drawing are understood to optionally apply to similar elements depicted in other drawings, either individually or in combination. It is therefore to be understood that numerous modifications may be made to the illustrative embodiments and that other arrangements may be devised without departing from the spirit and scope of the present disclosure, and as defined by the appended claims.

What is claimed is:

1. A method comprising:
obtaining observational data comprising interaction data on a user computing device;
detecting, in a communication application executing on the user computing device, a command to send an electronic communication;
determining a risk level of the electronic communication based on analyzing the interaction data, the risk level corresponding to a likelihood that the electronic communication is not generated by a human user; and
when the risk level of the electronic communication is below a risk threshold,
associating a validation indicator with the electronic communication, and
allowing the sending of the electronic communication to proceed;
wherein the method is performed by one or more processors.

2. The method of claim 1, further comprising:
when the risk level of the electronic communication is above the risk threshold, preventing sending of the electronic communication.

3. The method of claim 1, further comprising:
when the risk level of the electronic communication is above the risk threshold, sending a notification to a monitoring entity indicating that the user computing device is compromised.

4. The method of claim 1, wherein associating the validation indicator with the electronic communication comprises signing the electronic communication before allowing the sending of the electronic communication to proceed.

5. The method of claim 1, wherein associating the validation indicator comprises adding the validation indicator to metadata of the electronic communication.

6. The method of claim 1, wherein the electronic communication is an email.

7. The method of claim 1, further comprising:
obtaining electronic communication content corresponding to an incoming electronic communication;
verifying a second validation indicator associated with the incoming electronic communication; and
determining that a risk level of the incoming electronic communication is low based at least in part on verifying the second validation indicator associated with the incoming electronic communication.

8. The method of claim 1, wherein the observational data further comprises environmental data, and determining the risk level of the electronic communication is based on the environmental data.

9. The method of claim 1, wherein the observational data further comprises platform data, and determining the risk level of the electronic communication is based on the platform data.

10. The method of claim 1, further comprising:
maintaining a device score for the user computing device based on risk levels for multiple electronic communications sent from the user computing device;
wherein determining the risk level of the electronic communication is based on the device score.

11. The method of claim 1, further comprising:
maintaining a user score for a user of an electronic communication account based on risk levels for multiple electronic communications sent from the electronic communication account of the user;
wherein determining the risk level of the electronic communication is based on the user score.

12. A non-transitory computer-readable medium storing instructions that, when executed by one or more processors of a computer system, cause the computer system to:
obtain observational data comprising interaction data on a user computing device;
detect, in a communication application executing on the user computing device, a command to send an electronic communication;
determine a risk level of the electronic communication based on analyzing the interaction data, the risk level corresponding to a likelihood that the electronic communication is not generated by a human user; and
when the risk level of the electronic communication is below a risk threshold,
associate a validation indicator with the electronic communication, and
allow sending of the electronic communication to proceed.

13. The non-transitory computer-readable medium of claim 12, wherein the instructions, when executed by one or more processors of a computer system, cause the computer system to:
when the risk level of the electronic communication is above the risk threshold, prevent sending of the electronic communication.

14. The non-transitory computer-readable medium of claim 12, wherein the instructions, when executed by one or more processors of a computer system, cause the computer system to:
when the risk level of the electronic communication is above the risk threshold, sending a notification to a monitoring entity indicating that the user computing device is compromised.

15. The non-transitory computer-readable medium of claim 12, wherein associating the validation indicator with the electronic communication comprises signing the electronic communication before allowing the sending of the electronic communication to proceed.

16. The non-transitory computer-readable medium of claim 12, wherein associating the validation indicator comprises adding the validation indicator to metadata of the electronic communication.

17. The non-transitory computer-readable medium of claim 12, wherein the electronic communication is an email.

18. The non-transitory computer-readable medium of claim 12, wherein the instructions, when executed by one or more processors of a computer system, cause the computer system to:
obtain electronic communication content corresponding to an incoming electronic communication;
verify a second validation indicator associated with the incoming electronic communication; and
determine that a risk level of the incoming electronic communication is low based at least in part on verifying the second validation indicator associated with the incoming electronic communication.

19. The non-transitory computer-readable medium of claim 12, wherein the instructions, when executed by one or more processors of a computer system, cause the computer system to:
maintain a device score for the user computing device based on risk levels for multiple electronic communications sent from the user computing device;
wherein determining the risk level of the electronic communication is based on the device score.

20. A computer system comprising:
one or more hardware processors;
at least one memory storing one or more instructions which, when executed by the one or more hardware processors, cause the one or more hardware processors to:
obtain observational data comprising interaction data on a user computing device;
detect, in a communication application executing on the user computing device, a command to send an electronic communication;
determine a risk level of the electronic communication based on analyzing the interaction data, the risk level corresponding to a likelihood that the electronic communication is not generated by a human user; and
when the risk level of the electronic communication is below a risk threshold,
associate a validation indicator with the electronic communication, and
allow sending of the electronic communication to proceed.
